(19) United States
(12) Patent Application Publication
(10) Pub. No.: US 2008/0095942 A1
(43) Pub. Date: Apr. 24, 2008

(54) CERAMIC-FORMING POLYMER MATERIAL

(76) Inventors: Walter J. Sherwood JR., Clifton Park, NY (US); Lynn A. Tarnowski, Troy, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/954,036

(22) Filed: Dec. 11, 2007

Related U.S. Application Data
(62) Division of application No. 11/157,540, filed on Jun. 21, 2005.
Application No. 11/157,540 is a continuation-in-part of application No. 10/340,027, filed on Jan. 10, 2003, now abandoned.

(51) Int. Cl. B05D 3/02; C08G 77/12

(52) U.S. Cl. 427/314; 427/379; 528/31

(57) ABSTRACT

Disclosed is a polymer material comprised of at least one non-cyclic ceramic-forming polymer. The porosity and elemental composition of the resulting ceramic can be varied by inclusion of polymers with particular ratios of carbon, silicon, oxygen, and hydrogen and by manipulation of the conditions under which the polymer material is converted to a ceramic. The resulting ceramic may be useful in fiber-reinforced ceramic matrix composites (CMCs), semiconductor fabrication, fiber coatings, friction materials, and fire resistant coatings.

### CROSS REFERENCE TO RELATED APPLICATIONS

This application is a divisional application, with designated Attorney Docket No. STAR-0006-CIP-DIV1, of co-pending U.S. patent application Ser. No. 11/157,540, filed Jun. 21, 2005, which is a continuation-in-part of abandoned U.S. patent application Ser. No. 10/340,027, filed Jan. 10, 2003, each which are hereby incorporated herein by reference. This divisional application is co-pending with: another divisional application, with designated Attorney Docket No. STAR-0006-CIP-DIV2, of co-pending U.S. patent application Ser. No. 11/157,540; and P.C.T. Application No. PCT/US2006/024062, which claims priority of U.S. patent application Ser. No. 11/157,540. This divisional application is also co-pending with PCT/US2004/00604, filed Jan. 9, 2004, which claims priority of U.S. patent application Ser. No. 10/340,027.

### BACKGROUND OF THE INVENTION

(1) Technical Field

The present invention relates generally to polymers capable of forming ceramics, and more specifically, to a polymer material comprised of at least one non-cyclic, ceramic-forming polymer capable of forming oxidation-resistant ceramics with primarily silicon-carbon bonds.

(2) Related Art

Referring to FIGS. 1 and 2, ceramic composites are conventionally composed of three parts including: a group of fibers 1 or “tows” surrounded by a “weak interface” 2. The fibers are embedded in a ceramic matrix 3 to make the composite. In many coating processes there is also a phenomenon called “bridging” 4 in which the coating bonds the fibers together.

Fiber-reinforced ceramic-matrix composites, unlike typical polymer composites, require a weak fiber to matrix interfacial bond strength to prevent catastrophic failure from propagating matrix cracks through the fiber reinforcement. In particular, the interface must provide sufficient fiber/matrix bonding for effective load transfer, but must be weak enough to de-bond and slip in the wake of matrix cracking while leaving the fibers to bridge the cracks and support the far-field applied load. In other words, the interface material provides “crack-stopping” by allowing the fiber to slide in the interface coating at the fiber-coating interface 6. In some cases, the coated fiber can move in the matrix by sliding at the coating-matrix interface 7. In most cases, however, the coating material itself is designed to be of much lower strength than either the fiber or the matrix. This situation has historically limited the choice of materials. Typically, the fiber-matrix interface is provided as a pyro-carbon, boron nitride, or a duplex coating having carbon or boron nitride over-coated with silicon carbide.

The coatings are usually applied by a chemical vapor deposition (CVD) process. For example, the CVD process can produce oxide or non-oxide (and carbon) coatings. However, the CVD process is complex and expensive. As a result, it is not unusual for the cost of coating fiber cloth to be significantly more expensive than the cloth itself. Another disadvantage of the CVD process is that control of the coating's thickness varies over large fabric areas. Ceramic forming sol-gel precursors have also been used to form the boron nitride or oxide fiber coatings. However, the sol-gel process, while not expensive, produces primarily oxide materials.

The above described fiber coatings such as carbon and boron nitride have demonstrated the desired mechanical characteristics necessary to enhance the composite strength and toughness. However, the utility of these composites is severely limited by their susceptibility to oxidation brittleness and strength degradation at or beyond the matrix cracking stress point and subsequent exposure to high-temperature oxidation. The accelerated environmental degradation of the fiber coating occurs at elevated temperatures in air following the onset of matrix cracking.

Silicon oxycarbide-forming polymers such as Honeywell's Black Glas have been recently qualified for limited commercial/military use as matrix materials for ceramic matrix composites (CMCs). Until recently, oxycarbide-forming or oxynitride-forming pre-ceramic polymers were much less expensive than more stoichiometric SiC-forming polymers.

Silicon oxycarbide materials have been formed by both sol-gel processing and by the pyrolysis of ceramic precursor polymers. Those formed by sol-gel processing suffer from high porosity and severe shrinkage during pyrolysis. Oxycarbide ceramic-forming polymers such as “Black Glas” are typically composed of cyclosiloxanes and vinyl cyclosiloxanes, or polyphenylsiloxanes, which shrink much less during pyrolysis than sol-gel derived oxycarbides. This lower shrinkage coupled with reduced porosity of the resulting ceramic have made oxycarbide ceramics the choice for CMC production.

However, each of the above materials has shown the tendency to severely degrade in intermediate temperature oxidizing environments (e.g., air at 600-1000° C.) or at high temperature (e.g., 1300-1800° C.) inert or oxidizing environments. The degradation in oxidizing environments includes loss of carbon as carbon monoxide or carbon dioxide, which results in a radical change in mechanical, electrical, and thermal properties of the resulting ceramic. Degradation at high temperatures can also include a loss of carbon, but may additionally be the result of carbothermal reduction (reacting of unbound or insufficiently bound carbon with silica in the ceramic) to form SiC and carbon monoxide or carbon dioxide.

It has been shown that the structure of the ceramic formed by pyrolysis of Black Glas is greatly influenced by pyrolysis temperature. The chemical structure of the polymer-derived ceramic was also shown to influence the oxidation behavior.

In addition, most surface modification agents and binders, such as PTFE, fluoropolymers, and other organic modifiers, function at relatively low temperatures (e.g., generally below about 300-400° C.). Many modern processes, however, require operation at much higher temperatures. Accordingly, fiber coatings, surface films, friction components, and composite matrices need to be stable for long periods at temperatures above about 400° C. None of the organic materials known in the art function adequately above about 400° C. and newer silicate and aluminosilicate materials are of limited applicability, since they cannot easily be modified.

The critical requirement of an oxidation-stable non-oxide or silicon-based ceramic-forming polymer is to have the polymer form predominantly SiC₄ bonding (which is stoichiometric SiC) upon pyrolysis. This is what is formed during pyrolysis of SMP-10, a commercial SiC forming polymer from Starfire Systems, Inc. However, it is very expensive to create a polymer that pyrolyzes only to SiC with few impurities.

An alternative and less expensive route to produce an oxidation-resistant ceramic would be to incorporate controlled amounts of carbon and oxygen into the polymer. The oxygen-containing group can serve as a bridge to form the polymer or as a pendant group that assists in crosslinking (e.g., OH). However, the way in which the silicon, carbon, and oxygen are bonded together in the polymer has a critical effect on the resulting structure of the ceramic and its resulting oxidation behavior and high-temperature stability. Based on recent work, the desired constituents of an oxidatively-stable ceramic are listed below in order of importance, with 1 being the most desirable and 5 the least desirable.

1. SiO₄—Silica

2. SiC₄—Stoichiometric SiC

3. SiC₃O

4. SiCO₃

5. SiC₂O₂

However, thermal stability against carbothermal reduction requires a minimal amount of SiO₄ in the pyrolyzed ceramic. Accordingly, the desired constituents for high-temperature thermal stability are listed below in order of importance, with 1 being the most desirable and 5 the least desirable.

1. SiC₄—Stoichiometric SiC

2. SiC₃O

3. SiCO₃

4. SiC₂O₂

5. SiO₄—Silica

Accordingly, the best overall material for both oxidation-resistance and high-temperature stability is stoichiometric SiC. There is, therefore, a need in the art for ceramic-forming polymer materials capable of forming ceramics comprised primarily of stoichiometric SiC that resist oxidation and are stable at high temperatures.

### SUMMARY OF THE INVENTION

The present invention describes polymer materials comprising at least one non-cyclic ceramic-forming polymer. The porosity and elemental composition of the resulting ceramic can be varied by the inclusion of polymers with particular ratios of carbon, silicon, oxygen, and hydrogen and by the manipulation of the conditions under which the polymer material is converted to a ceramic. The resulting ceramic may be useful in fiber-reinforced ceramic matrix composites (CMCs), semiconductor fabrication, fiber coatings, friction materials, and fire resistant coatings.

The ceramic-forming polymer materials of the invention can be applied by a number of means, including spraying, dipping, direct mixing with fillers, and vacuum infiltration. As a result, the ceramic-forming polymer materials of the invention are useful in a wider array of applications than are existing methods of ceramic formation.

A first aspect of the invention provides a compound of formula I 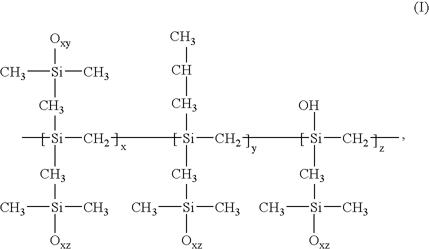
wherein x is between about 0.75 and about 0.9, y is between about 0.05 and about 0.15, and z is between about 0.05 and about 0.20.

A second aspect of the invention provides a compound of formula II 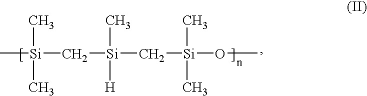
wherein n is greater than 2.

A third aspect of the invention provides a method of modifying a friction coefficient of a material comprising the steps of applying to the material at least one polymer of formulas I, II, or III, 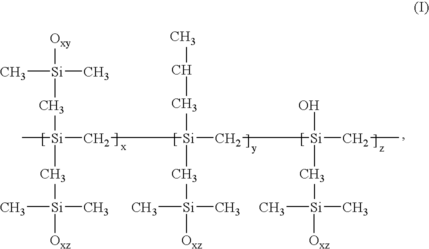
wherein x is between about 0.75 and about 0.9, y is between about 0.05 and about 0.15, and z is between about 0.05 and about 0.20, 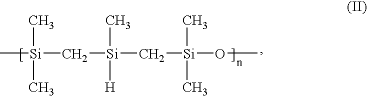
wherein n is greater than 2, 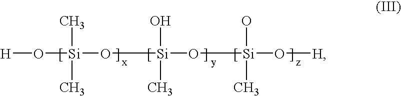
wherein x is between about 0.02 and about 0.08, y is between about 0.08 and about 0.20, and z is between about 0.72 and about 0.90, drying the material, and heating the material.

A fourth aspect of the invention provides a method of coating a fiber material comprising the steps of desizing the fiber material, coating the fiber material with at least one polymer of formulas I, III, or III, 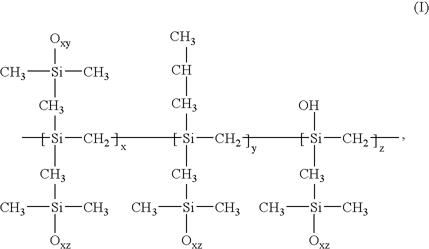
wherein x is between about 0.75 and about 0.9, y is between about 0.05 and about 0.15, and z is between about 0.05 and about 0.20, 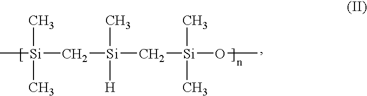
wherein n is greater than 2,

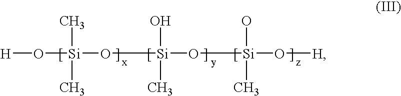

wherein x is between about 0.02 and about 0.08, y is between about 0.08 and about 0.20, and z is between about 0.72 and about 0.90, drying the fiber material, and heating the fiber material.

A fifth aspect of the invention provides a friction material comprising a metallic material, a carbon-type material, and an in situ formed ceramic material formed by pyrolizing at least one polymer of formulas I, II, or III, 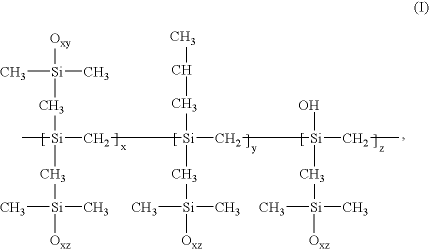
wherein x is between about 0.75 and about 0.9, y is between about 0.05 and about 0.15, and z is between about 0.05 and about 0.20, 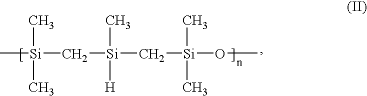
wherein n is greater than 2,

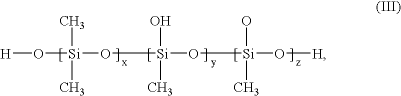

wherein x is between about 0.02 and about 0.08, y is between about 0.08 and about 0.20, and z is between about 0.72 and about 0.90.

A sixth aspect of the invention provides a coated fiber material comprising a fiber material, and an in situ formed ceramic material formed by pyrolizing at least one polymer of formulas I, II, or III, 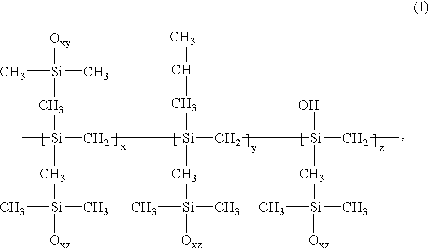
wherein x is between about 0.75 and about 0.9, y is between about 0.05 and about 0.15, and z is between about 0.05 and about 0.20, 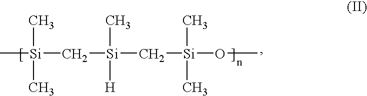
wherein n is greater than 2, 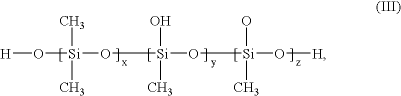
wherein x is between about 0.02 and about 0.08, y is between about 0.08 and about 0.20, and z is between about 0.72 and about 0.90.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows a conventional ceramic composite.

FIG. 2 shows a conventional ceramic composite.

FIG. 3A shows a ceramic composite according to one embodiment of the invention.

FIG. 3B shows a ceramic composite according to another embodiment of the invention.

FIG. 4 shows the chemical structure of QS-15-003, an Si—C/Si—C—O ladder polymer.

FIG. 5 shows the chemical structure of QS-15-017, a linear Si—C/Si—C—Si—O polymer.

FIG. 6 shows the chemical structure of SOC-A35, a polymethylsesqusiloxane polymer.

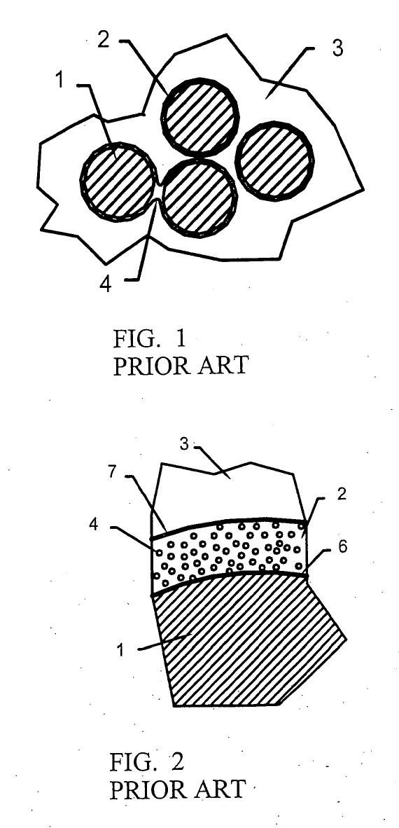

### DETAILED DESCRIPTION

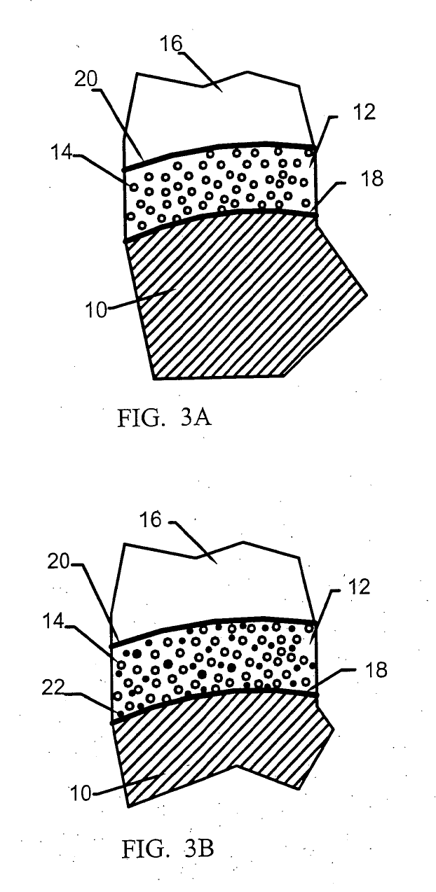

Referring to FIGS. 3A-B, the invention includes a ceramic composite comprising: a fiber material 10, and a ceramic coating 12 over fiber material 10 where the ceramic coating is formed from a non-cyclic ceramic forming polymer. (Note: FIG. 3A appears similar to FIG. 2, however, the materials used in FIG. 3A are according to the invention.) A ceramic matrix 16 is provided over ceramic coating 12 and fiber material 10. The non-cyclic ceramic forming polymer may be selected from the group comprising: polycarbosilane, hydridopolycarbosilane, polyhydridosilane, polyhyridosilazane, polysiloxane, polysesquilsiloxane and high char yield hydrocarbon polymer. Ceramic composite 12 may include carbon, silicon, and oxygen. Ceramic coating 12 has a plurality of nanoscale pores 14 that impart a lower strength to the coating relative to fiber material 10 and matrix 16. As a result, the ceramic-matrix composite provides a weak fiber material 10 to matrix 16 interfacial bond strength and prevents catastrophic failure from propagating matrix cracks. In particular, the composite provides sufficient fiber/matrix bonding for effective load transfer, but is weak enough to de-bond and slip in the wake of matrix cracking while leaving fiber material 10 to bridge the cracks and support the far-field applied load. The interface material provides “crack-stopping” by allowing the fiber to slide in the interface coating at the fiber material-coating interface 18. In some cases, fiber material 10 can move in matrix 16 by sliding at the coating-matrix interface 20.

Methods of forming the ceramic composite include: providing a fiber material; coating the fiber material with one of the above-described ceramic forming polymers; and curing the ceramic forming polymer.

Fiber material 10 may take a variety of forms. For instance, fiber material 10 may take the form of one of: a fiber tow, fiber cloth, a woven fiber preform, a chopped fiber preform, a chopped fiber felt, whiskers, fiber filaments, and a particulate or platelet. Material may be made of, for example, one or more of a carbon fiber, a graphite fiber, a ceramic fiber, a polyacrylnitrile-based fiber, a pitch-based carbon fiber, silicon carbide, near-silicon carbide, silicon borocarbide, silicon carbonitride, silicon nitrocarbide, a refractory metal, a refractory metal carbide, a refractory metal boride, a refractory metal nitride, alumina, mullite, silicon dioxide, or an aluminosilicate.

If carbon fiber is selected, in one embodiment, the carbon fiber may be an acrylic-derived fiber based on polyacrylnitrile (PAN) such as those designated T-300, AS-4, T-650, T-700, and T-1000 available from, for example, Toray or Amoco. In another embodiment, material may include carbon fibers that are pitch-based carbon fibers such as those designated P-25, P-55, P-75, K-700, K-1100, CN-80, and CN-60, available from, for example, Conoco or Mitsubishi. In another embodiment, the fibers may be a non-oxide fiber chosen from the group comprising: silicon carbide, near-silicon carbide, silicon borocarbide, silicon carbonitride, or silicon nitrocarbide (SiNC) fibers. Commercial examples of these materials include: Nicalon, Hi-Nicalon, or Hi-Nicalon type-S, available from Nippon Carbon; Sylramic or Sylramic treated to form a boron-nitride (BN) interface, available from COI Ceramics; Tyranno LOX E, Tyranno ZMI, or Tyranno SA-type, available from UBE Ltd.

In another embodiment, fiber material 10 may be chosen from the group comprising: refractory metal, refractory metal carbide, refractory metal boride, or refractory metal nitride fibers. Illustrative fibers of this type include: hafnium carbide, hafnium nitride, hafnium diboride, rhenium, tantalum, tantalum carbide, or tantalum nitride.

In another embodiment, fiber material 10 may include oxide fiber chosen from the group comprising: alumina, mullite and aluminosilicate. Commercial examples of these fibers include Nextel 312, Nextel 312BN, Nextel 440, Nextel 610, and Nextel 720, available from 3M Corp.

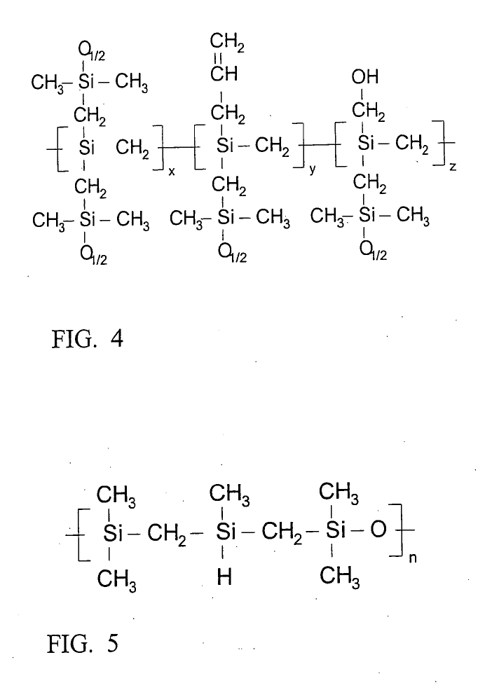

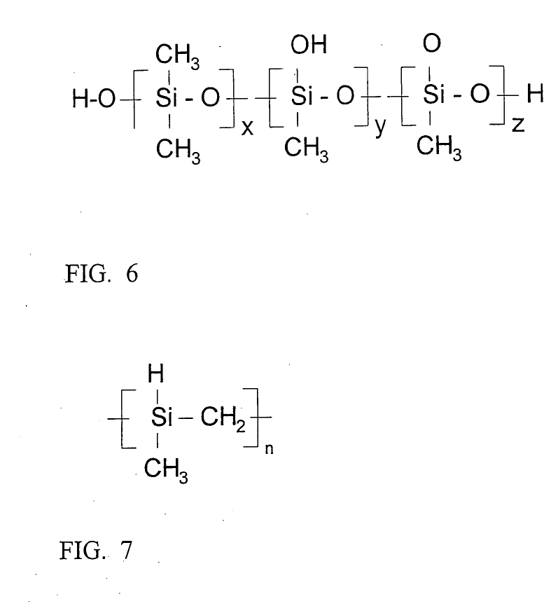

The ceramic forming polymer material is specially formulated to provide the desired coating properties on the particular fiber material chosen. The material may be of the following types: silicon oxycarbides (SOC), carbon-rich silicon carbides, carbon-rich SOC, carbon forming polymers, or mixtures of the aforementioned polymers. As discussed above, in general terms the ceramic forming polymer may be designated as a non-cyclic ceramic forming polymer and/or as containing carbon, silicon, oxygen and hydrogen. More particularly, in one embodiment, the ceramic forming polymer may be selected from the group comprising: polycarbosilane, hydridopolycarbosilane, polyhydridosilane, polyhyridosilazane, polysiloxane, polysesquilsiloxane and high char yield hydrocarbon polymer. In addition, ceramic forming polymer further may also include boron at no less than 0.25% by weight and at no greater than 5% by weight. Illustrative chemical structures are shown in FIGS. 4-6. FIG. 4 shows the chemical structure of a branched QS-15-003 precursor that forms a porous carbon-rich oxycarbide ceramic coating 12. FIG. 5 shows the chemical structure of a linear QS-15-017 precursor that forms a porous oxycarbide ceramic coating 12. FIG. 6 shows the chemical structure of SOC-A35, a high yield meltable solid SOC that forms a very high temperature stable, low carbon, porous oxycarbide ceramic coating 12. (In FIG. 6, x=0.02-0.08 parts, y=0.08-0.20 parts, and z=0.72-0.90 parts).

Many of the above-described polymers can be used to coat fiber material without further preparation. For example, the linear oxycarbide precursor (FIG. 5) can be used as is. However, some of the above-mentioned polymers, e.g., the high-yield, meltable SOC (FIG. 6), are solids that must be dissolved in a solvent to enable coating. Still others are high-yield liquids, e.g., the branched oxycarbide SOC (FIG. 4), that require dissolving in a solvent to enhance coating uniformity on fiber material. Where a solvent is required, the solvent may be selected from aromatic hydrocarbons or aliphatic hydrocarbons such as: tetrahydrofuran, hexane, heptane, octane, ether, acetone, ethanol, methanol, toluene and isopropyl alcohol. The type of solvent used will vary depending on the polymer. For instance, typically ethanol, toluene, or acetone is used with SOCs. Similarly, hexane, tetrahydrofuran, or toluene are preferred for carbon-rich SOCs, carbon-rich silicon carbides, or carbon polymers.

The amount of polymer required is chosen such that the resulting coating on fiber material 10 has a thickness of no less than 0.005 micron and no greater than 3 microns depending on the type and diameter of the fiber. Preferably, the thickness is no less than 0.25 microns and no greater than 0.6 microns. It has been discovered that these thicknesses improve the oxidation resistance of fiber material 10 in matrix 16, and improves the toughness of ceramic matrix, glass matrix, and organic polymer matrix composites. In most cases, these thicknesses result in the mass of the polymer needed for coating a given fiber being between 5% and 25% of the fiber mass (for carbon, silicon carbide, silicon nitride, silicon carbonitride, alumina, and aluminosilicate fibers). Denser fibers or whiskers such as hafnium carbide or hafnium nitride would require polymer masses that are roughly 1% to 5% of the fiber masses.

The ceramic forming polymer is dissolved in sufficient solvent, when necessary, to permit uniform distribution of the polymer throughout fiber material 10. Typically, the ceramic forming polymer is between 50% and 250% of the mass of the composite depending upon the application method. Lower solvent levels would be used for dip-coating of fabric, thin woven performs, or tows, while larger solvent levels would be used for spraying or coating thick felts or dense preforms.

The actual coating process may include spraying, including spraying through an ultrasonic nozzle, dipping, soaking, and vacuum infiltrating the ceramic forming polymer onto fiber material 10. In one embodiment, the solvent may be rapidly driven off by flowing warm air to minimize wicking, which could decrease the uniformity of the fiber coating.

In an alternative step, fiber material 10 may be heated to at least 1600° C. and no greater than 2200° C. for at least one hour and no more than two hours prior to the coating step to aid in the uniform distribution of the polymer.

Once the coating has been applied and the solvent removed, the coating is thermally cured, i.e., by heating. Depending on the polymer type, the curing atmosphere may occur in an atmosphere containing an inert gas (e.g., nitrogen, argon, helium) and may include an active gas such as oxygen, hydrogen, air, and ammonia. Where an active gas is provided, the active gas makes up no less than 2% by volume and no more than 50% by volume of the atmosphere, with a preferred range of approximately 25%-40%. Where hydrogen is used, the atmosphere includes no less than 2% by volume hydrogen and no more than 10% by volume hydrogen, and preferably between 4%-7%.

The curing of the coating materials is accomplished in a number of ways depending on the ceramic forming polymer used. For the branched and linear SOCs shown in FIGS. 4 and 5, curing is done by heating (e.g., in flowing inert gas) at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. (also in inert gas or in selected active gases noted previously) with a 0.5-2 hour hold at that temperature will cure the fiber coating resin. For the high yield, meltable SOC polymer in FIG. 6, curing is accomplished by heating in flowing inert gas at a nominal rate of approximately 2° C. per minute up to approximately 100° C., with a hold at approximately 100° C. for approximately 1 hour per inch of thickness of fiber material 10. Further heating at 0.5-1° C. per minute to 150-250° C. (e.g., in air) with a one to four hour hold at that temperature will cure the fiber coating polymer.

After the above processing, coating 12 is fired in an inert gas at increments of approximately 2° C. per minute up to a temperature of 850-1150° C. and held for one hour at the temperature to convert the polymer to ceramic. Multiple coating cycles (with the same or different polymers) can be used to produce a multi-layer interface coating such as may be needed for densification of the composite by infiltration with molten silicon or other metals such as aluminum.

The polymer in FIG. 6 forms a ceramic composite similar to that shown in FIG. 3A with a large number of nano-scale pores 14 in fiber coating 12. The coating will crack between pores 14 to provide the weak interface. When used with certain carbon fibers, ceramic coating 12 will also fail at fiber material-coating interface 18. The polymers shown in FIGS. 4 and 5 typically form a coating similar to the concept shown in FIG. 3B, where ceramic coating 12 includes both pores 14 and carbon rich areas 22 that provide a weak interface and a source of oxygen absorbing media (the carbon rich areas) to provide an interface that protects fiber material 10 more effectively in an oxidizing environment.

Once the fiber coating has been applied, further processing/densification of the ceramic composite may be accomplished by forming a matrix 16 of ceramic or metal between the coated fibers to increase the density of the composite. In one embodiment, the density in increased by infiltrating the ceramic preform or fibers with one or more types of ceramic forming polymers and proceeding through one or more curing and pyrolysis cycles. The infiltrating ceramic forming polymer may be chosen from, for example, a silicon carbide forming polymer, silicon nitride (SiN) forming polymer, silicon nitrocarbide (SiNC) forming polymer, silicon carbonitride (SiCN) forming polymer and SOC forming polymer. Silicon carbide is available from Starfire Systems, Inc.; SiN is available from Clariant, and under the trade name HPZ from COI Ceramics, Inc.; SiNC materials is available from Matech/Global Strategic Materials; SICN under the trade name “Ceraset” is available from Kion Corporation; and SOC polymer is available from COI Ceramics, Inc, Honeywell, Starfire Systems Inc. or Matech/Global Strategic Materials.

In another embodiment, increasing the density of the ceramic composite may be completed by infiltrating the composite with one of a carbon forming material and a molten silicon or another molten metal. In another embodiment, the density of the ceramic composite is increased by chemical vapor infiltrating with one of carbon, graphite, and silicon carbide.

### EXAMPLE 1

### Coating Polyacronitrile-Based Carbon Fibers

A 50 gram polyacronitrile (PAN) based carbon fiber disk preform is heat treated by heating in inert gas to 1600° C.-1800° C. for 2 hours. An amount of oxycarbide such as Starfire System's silicon oxycarbide SOC-A35 (FIG. 6) may be used for the ceramic coating. As an alternative, other silicon oxycarbide such as those shown in FIGS. 4 and 5 may be used. In any case, an amount of polymer roughly equal to 18%-22% of the mass of the preform is weighed out on, for example, a three-place analytical balance. An amount of ethyl alcohol, or toluene roughly equal to 150% to 200% of the mass of the preform is weighed out. The polymer is dissolved in the solvent by, for example, stirring in a beaker or flask using a magnetic driven stirrer driving a polytetrafluoroethylene (PTFE) coated stir bar. The polymer is slowly added to the solvent while stirring until all is added. The solution is stirred until all of the polymer is dissolved and the solution becomes clear, which may take, for example, 15 minutes to 1 hour. The preform is placed in a tub and the polymer solution is then poured over the preform. The coated preform is then placed into a vacuum or inert gas oven to remove and recover the solvent and cure the polymer. In this case, the curing atmosphere will be air, although nitrogen can also be used. The heating occurs at an incremental rate of approximately 2° C. per minute up to approximately 100° C., with a hold at approximately 100° C. for approximately 1 hour per inch of thickness of fiber material 10. Further heating at 0.5-1° C. per minute up to 150-250° C. (e.g., in air) with a one to four hour hold at that temperature will cure the fiber coating polymer. Following the cure cycle, the coated preform is fired in inert gas at increments of 2° C. per minute up to 850-1150° C. and held at temperature for approximately one hour to convert the polymer coating to ceramic. Once cool, the preform is ready for rough machining to near net shape and/or for infiltration with the matrix material.

### EXAMPLE 2

### Coating Near-Stoichiometric Silicon Carbide Fibers

A square foot of cloth composed of near-stoichiometric silicon carbide fiber such as Sylramic, or Tyranno SA, or Hi-Nicalon type-S is first desized (the organic coating needed to allow weaving the fibers) by heating to 350-500° C. in air for about 4 hours or to 850° C. in inert gas for about one to two hours. An amount of oxycarbide forming polymer such as Starfire System's QS-15-017 (FIG. 5), QS-15-003 (FIG. 4) or carbon rich polycarbosilane ceramic forming polymer roughly equal to 8-11% of the mass of the cloth is weighed out on a three-place analytical balance. An amount of hexane, or tetrahydrofuran approximately equal to 100%-150% of the mass of the cloth is weighed out. The polymer is dissolved in the solvent by stirring in a beaker or flask using a magnetic driven stirrer driving a PTFE-coated stir bar. The polymer is slowly added to the solvent while stirring until all is added. The solution is stirred until all of the polymer is dissolved and the solution becomes clear, e.g., approximately 15 minutes to 1 hour. The fabric is placed in an aluminum foil boat and the polymer solution is then poured over the cloth. Alternatively, for longer rolls of fabric, the cloth can be pulled through a trough containing the polymer solution. Next, the cloth is run though rollers to remove excess liquid and is then passed over flowing warm air to remove the solvent. In this case, the coated fabric is placed into a vacuum or inert gas oven to remove and recover the solvent and cure the polymer. In this example, the curing atmosphere is nitrogen, although air can be used. The heating process may include: heating (e.g., in flowing inert gas) at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. (also in inert gas or in selected active gases noted previously) with a 0.5-2 hour hold at that temperature will cure the fiber coating resin. Following the cure cycle, the coated preform is fired in inert gas at increments of 2° C. per minute up to 850-1150° C. and held at temperature for approximately one hour to convert the polymer coating to ceramic. Once cool, the fabric is ready to be stacked up to form a laminated preform prior to infiltration with the matrix material.

### EXAMPLE 3

### Coating Silicon Oxycarbide (Si—C—O) or Carbon-Rich Silicon Carbide

A 50 gram woven preform composed of Hi-Nicalon, Ceramic Grade Nicalon, Tyranno LOX-M, Tyranno LOX-E or ZMI fiber is first desized by heating to 350-500° C. in air for about four hours or to 850° C. in inert gas for about one to two hours. An amount of SOC such as the polymers in FIG. 4 or 5 roughly equal to 8-25% of the mass of the preform is weighed out on a three-place analytical balance. An amount of toluene solvent roughly equal to 75%-150% of the mass of the preform is weighed out. The polymer is dissolved in the solvent by stirring in a beaker or flask using a magnetic driven stirrer driving a PTFE-coated stir bar. The polymer is slowly added to the solvent while stirring until all is added. The solution is stirred until all the polymer is dissolved and the solution becomes clear, e.g., approximately 15 minutes to 1 hour. The preform is placed in an aluminum foil boat and the polymer solution is then poured over the preform. The coated preform is then placed into a vacuum or inert gas oven to remove and recover the solvent and cure the polymer. Depending on the coating polymer type, the curing atmosphere will be either air or nitrogen. The heating process may include: heating (e.g., in flowing inert gas) at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. (also in inert gas or in selected active gases noted previously) with a 0.5-2 hour hold at that temperature will cure the fiber coating resin. Following the cure cycle, the coated preform is fired in inert gas at increments of 2° C. per minute up to 850-1150° C. and held at temperature for approximately one hour to convert the polymer coating to ceramic. Once cool, the preform is ready for rough machining to near net shape and/or for infiltration with the matrix material.

### EXAMPLE 4

### Coating Oxide Fibers

An area of cloth (e.g., a square foot) composed of oxide-based fibers such as Nextel 312 (aluminosilicate with boron), Nextel 440 (non-stoichiometric mullite), Nextel 720 (near stoichiometric mullite), Nextel 610 (alumina), Silica, or Saffil (alumina) is first desized by heating to 350-500° C. in air for about four hours or to 850° C. in inert gas for about one to two hours. An amount of SOC, such as Starfire QS-15-017 (FIG. 5), and carbon forming polymers (e.g., Zeco-11, SC-1008, or Furfural), mixed in a 75:25 ratio, are weighed out on a three-place analytical balance to form a total mass equal to roughly 20% of the mass of the cloth. An amount of tetrahydrofuran or toluene solution roughly equal to 100%-150% of the mass of the cloth is also weighed out. The polymer is dissolved in the solvent by stirring in a beaker or flask using a magnetic driven stirrer driving a PTFE-coated stir bar. The polymer is slowly added to the solvent while stirring until all is added. The solution is stirred until all of the polymer is dissolved and the solution becomes clear, e.g., approximately 15 minutes to 1 hour. The fabric is placed in an aluminum foil boat and the polymer solution is then poured over the cloth. Alternatively, for longer rolls of fabric, the cloth can be pulled through a trough containing the polymer solution. Next, the cloth is run though rollers to remove excess liquid and is then passed over flowing warm air to remove the solvent. In this case, the coated fabric is placed into a vacuum or inert gas oven to remove and recover the solvent and cure the polymer. In this example, the curing atmosphere is nitrogen, although air can be used. The heating process may include: heating at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. with a 0.5-6 hour hold at that temperature will cure the fiber coating resin. Following the cure cycle, the coated preform is fired in inert gas at increments of 2° C. per minute up to 650-950° C. and held at temperature for approximately one hour to convert the polymer coating to ceramic. Once cool, the fabric is ready to be stacked up to form a laminated preform prior to infiltration with the matrix material.

### EXAMPLE 5

### Coating Silicon Oxide Fibers

A square foot of cloth composed of 95% Silicon Oxide (more accurately “silicon dioxide”) is first desized by heating to 350-500° C. in air for about four hours or to 850° C. in inert gas for about one to two hours. An amount of QS-15-017 silicon carbide forming polymer precursor and QS-15-003 carbon/oxygen doped silicon carbide forming precursor are mixed in a 50:50 ratio to make the fiber coating solution. An amount of the solution equal to roughly 15% of the mass of the cloth is weighed out on a 3-place analytical balance. An amount of tetrahydrofuran or toluene roughly equal to 100%-150% of the mass of the cloth is weighed out. The polymer is dissolved in the solvent by stirring in a beaker or flask using a magnetic driven stirrer driving a Teflon-coated stir bar. The polymer is slowly added to the solvent while stirring until all is added. The solution is stirred for 15 minutes to 1 hour (until all of the polymer is dissolved and the solution becomes clear). The fabric is placed in an aluminum foil boat and the polymer solution is then poured over the cloth, alternatively, for longer rolls of fabric, the cloth can be pulled through a trough containing the polymer solution and run though rollers to remove excess liquid and then passed over flowing warm air to remove the solvent. In this case the curing atmosphere is nitrogen, although air can be used. The heating rate is nominally 2° C. per minute up to 100° C., with a hold at 100° C. for 2 hours. Further heating at 2° C. per minute to 600-700° C. with a 1-2 hour hold under nitrogen or argon will cure and harden the coating. Once cool, the fabric is ready to be stacked up to form a laminated preform prior to infiltration with the matrix material.

The processes described in the above examples could also be easily modified within the scope of this invention to coat fiber cloth, fiber tows, chopped fibers, whiskers, or other fiber-based material.

Ceramic-forming polymers of the present invention may also be used as friction modifiers and surface modifiers. For example, polycarbosilanes (Si—C—Si—C backboned) and non-cyclic siloxanes may be used as surface modifiers by tailoring and controlling the position and amount of oxygen, hydroxyl, alkoxy, and organic (carbon-bearing) functional groups (e.g., methyl, ethyl, allyl, vinyl, propargyl, butyl, acetyl, etc.) on the backbone.

The friction properties of materials infiltrated by or coated with such functionally modified polycarbosilanes can be controlled from low friction (e.g., having a friction coefficient below about 0.1) to medium high friction (e.g., having a friction coefficient of between about 0.5 and about 0.6). Low friction materials have applications, for example, in bearings. Medium high friction materials are useful, for example, in braking applications. Other suitable uses for the polymers of the present invention include release coatings on molds or other components for protection from molten metals, molten glasses, pre-ceramic polymers, and other materials. In addition, it is possible to control electrical properties (e.g., conductivity and dielectric constant) of materials treated according to the present invention.

For example, as described more fully in the following examples, the ceramic-forming polymers of the present invention may be used to form uniformly dispersed, nano-structured ceramics that function as highly effective friction modifiers and friction materials and which are stable at higher temperatures than known friction materials. Suitable applications include, for example, brake pads, clutch pads, brake rotors, release coatings, and protective surface coatings.

### EXAMPLE 6

### Enhanced C/C Brake Rotor for Aircraft

A partially densified carbon/carbon aircraft brake rotor with 10%-15% open porosity is infiltrated with a solution of 50% QS-15-003 in Hexane by soaking the rotor in the solution for 2 hours followed by drying for 4 hours in flowing warm air. The infiltrated part is heated in nitrogen at 1 deg. C. per minute up to 850° C. and held for 1 hour. After cooling, the procedure is repeated until the part gains roughly 3%-5% in mass and the porosity decreases to <7%. The rotor has improved oxidation resistance and slightly improved friction performance. Alternatively, a solution of 20% SOC-A35 in ethanol can be used for one or more of the subsequent infiltration cycles to modify low-speed friction and improve wear resistance.

### EXAMPLE 7

### Ceramic Enhanced Non-Asbestos Organic (NAO) Pad

A disk brake pad is made by substituting 50% of the standard solid phenolic resin with FM-35 (a variant of SOC-A35 wherein z is approximately 0.9 and y is approximately 0.08) and processing by the nominal existing pad processing route. Once formed, the modified brake pad has ½ to ¼ the wear and slightly higher friction against cast iron and steel brake rotors compared to a pad made without the FM-35. The disk brake pad also is much more resistant to “fade” or loss of friction at high temperatures. Other SOC type of polymers such as SH-29-91-4 resins can also be utilized to enhance friction and wear.

### EXAMPLE 8

### Improved Simple Friction Pad

A brake pad for an automotive vehicle is formed from a material composed of 50% by mass copper mesh/felt and 50% by mass glassy carbon formed from furfural alcohol. The pad is infiltrated with a 50% solution of QS-15-003 in Hexane for 1 hour, dried for 1 hour in flowing warm air and fired in inert gas at 2 degrees per minute up to 850° C. and held for 1 hour. The infiltration and pyrolysis/firing process is repeated 4 times or until the mass gain is roughly 1.5% over the original mass of the part. This process increase the friction coefficient of the material from 0.15 to >0.35 against a carbon fiber reinforced ceramic rotor. Alternatively, FM-35 dissolved in toluene at a 15% solution can be substituted for QS-15-003 in one or more of the reinfiltration cycles to further modify friction and wear performance.

### EXAMPLE 9

### Enhanced Automotive Friction Pads

A set of high performance disk brake pads such as the “01” series pad manufactured by Performance Friction Inc. is heat treated to 850° C. in inert gas for 2 hours after heating at 2° C. per minute. After heating, the pads are vacuum infiltrated with a solution of 30% by mass SH-29-91-4 in toluene. The infiltrated pads are allowed to dry in flowing warm air for 1 hour and subsequently heated in an inert gas furnace at 1-2° C. per minute heating rate up to 850° C. with a 1 hour hold. After cooling the procedure is repeated until the pads gain roughly 3% in mass. The pad wear rates have decreased and friction has increased over non-treated pads such that against a carbon fiber reinforced SiC rotor they pass the FMVSS-135 qualification test for automotive use.

### EXAMPLE 10

### Motorcycle Friction Pad

A brake pad for a motorcycle is formed from a material composed of ˜50% by mass copper/brass, ˜5% by mass iron filings, and ˜30% by mass of carbon is produced using conventional brake pad sintering techniques. The pad is infiltrated with a 50% solution of FM-35 in toluene and soaked for one hour, dried for 1-2 hours in flowing warm air, and fired in inert gas at 2 degrees per minute up to 850° C. and held for 1 hour. The infiltration and pyrolysis/firing process is repeated 4 times or until the mass gain is roughly 0.5%-1.2% over the original mass of the part. This process increase the friction coefficient of the material from <0.2 to >0.4 against a ceramic composite rotor.

### EXAMPLE 11

### Friction Material

QS-15-003 is added to furfural alcohol at a 2.0-5.5% by mass and mixed thoroughly. The furfural alcohol/500B mixture is then infiltrated into a copper mesh/felt perform and slowly pyrolyzed to 650° C. to 750° C. over a 10-15 day cycle, to produce a copper-carbon material modified with QS-15-003. The material is vacuum infiltrated with a solution of 50% SH-29-91-4 in toluene, allowed to dry in warm flowing air for a minimum of one hour. The part is then heated at 1° C./min in inert gas to 850° C. and held for 1 hour. The infiltration and pyrolysis process is repeated until the part has a porosity of less than 8%. The material is then ready for machining into a brake pad or other friction component.

### EXAMPLE 12

### Friction Pad Material

Iron or steel wool, fine mesh iron or steel, or iron/steel felt is coated with solution of 50% QS-15-003 in Hexane, allowed to dry for ½ hour and heated at 2° C. per minute to 900-950° C. and held for 1-2 hours. The process is repeated 1-2 more times to produce a bonded coating on the steel fibers. The coating protects the steel from reacting with carbon. The coated steel wool, mesh, or felt is then infiltrated with furfural alcohol mixed with 20% by mass copper powder, and slowly pyrolyzed to 750° C. over a 10-15 day cycle. The component is then vacuum infiltrated with a 30% solution of FM-35 in toluene, dried for 1 hour in warm flowing air, and heated at 2° C. per minute in inert gas to 850° C. and held for 1 hour. Once cooled, the iron/steel/copper-carbon friction material is ready for machining into a low wear, moderate to high friction brake pad or other friction component.

### EXAMPLE 13

### High Friction, Low Wear Friction Material

Fine mesh iron or steel wool or felt is coated with copper by a plating process. The coating protects the steel from reacting with carbon. The coated steel wool or felt is then infiltrated with a mixture of 10-20% by mass finely ground (<100 mesh) glassy carbon in furfural alcohol and slowly pyrolyzed to 750° C. in inert gas over a 40 hour heating cycle with a 1-2 hour hold. The material is cooled to room temperature and vacuum infiltrated with a 30% solution of a special variant of SOC-A35 called FM-35 in ethanol. After drying in warm flowing air for 1-2 hours, the part is heated in inert gas at 1-2° C. per minute to 850° C. and held for 1-2 hours. The process is repeated until the part porosity is less than 7%. The material is then ready for machining into a brake pad or other friction component.

### EXAMPLE 14

### Low Cost Carbon/SiC Brake Rotor

A brake rotor for an automotive platform (car, truck, sport utility vehicle) is fabricated from 3K or 6K T-300 fabric that has been heat-treated to a minimum of 1600° C. for at least 2 hours in argon. The fabric is pre-pregged by soaking with a slurry composed of 50% by mass solution of SOC-A35 dissolved in ethanol and 55% by mass (of resin solids) silicon carbide powder in the size range of 0.4 micrometers to 7 micrometers. The solvent is dried leaving a somewhat stiff non-tacky fabric ply. Sufficient plies are stacked up to produce a final component with a fiber volume of between 25% and 45%. The stacked plies are warm-pressed by heating to 140-180° C. and pressing to shims set at the desired rotor thickness plus roughly 0.040″ of extra thickness for final grinding. Once the part reaches temperature it is further heated to 250-300° C. and holding for ½ hour to cure the part. The part is then pyrolyzed in nitrogen by heating under inert gas at 1-2 degrees per minute up to 850-10001° C. with a 1 hour hold. The part is then vacuum infiltrated with SMP-10 SiC-forming polymer and pyrolyzed in nitrogen by heating at 1-2 degrees per minute up to 850-1000° C. with a one-hour hold. The partially densified part is then vacuum infiltrated with SMP-10 SiC-forming polymer and pyrolyzed as done previously until a porosity of less than 7% is reached.

### EXAMPLE 15

### Non-Woven Carbon Reinforced Brake Rotor

A brake rotor for a light duty vehicle is fabricated by infiltrating needled Polyacronitrile based carbon fiber felt with a fiber volume fraction of 22% to 28% that was heat treated in argon to a minimum of 1600° C. for a minimum of 2 hours. The felt perform is infiltrated with slurry composed of a 30%-40% by mass solution of SOC-A35 in toluene and 10-20 mass percent fine (0.4 micrometer-4 micrometer size) silicon carbide powder and allowed to dry overnight. The soaked felt is then cured by heating to 180-200° C. in air with a 1 hour hold to cure the part. The part is then pyrolyzed in nitrogen by heating at 1-2 degrees per minute up to 850-1000° C. with a 1 hour hold. The part is reinfiltrated with the 25% solution of SOC-A35 in toluene and allowed to dry for 4-12 hours. The part is then pyrolyzed in nitrogen by heating at 1-2 degrees per minute up to 850-1000° C. with a 1 hour hold. The partially densified part is then vacuum infiltrated with SMP-10 SiC-forming polymer and pyrolyzed as done previously for two cycles. Following machining to near-net shape, the part is vacuum infiltrated with SMP 10 and again pyrolyzed. A minimum of four more infiltration and pyrolysis cycles are used to attain a porosity level of below 7%. The resulting low cost rotor is suitable for use with as a brake disk when used with pads designed for ceramic rotors.

### EXAMPLE 16

### Motorcycle or Automobile Brake Rotor

A brake rotor for a motorcycle or other automotive platform (car, truck, sport utility vehicle) is fabricated from 20-40 sheets of 14″×14″ 3K or 6K T-300 fabric that has been heat treated to a minimum of 1600° C. for at least 2 hours in argon. The fabric is pre-coated with solution of 10% QS-15-003 in Hexane, allowed to dry for ½ hour and heated at 2° C. per minute to 850° C. and held for 1-2 hours. The fabric is then coated with a slurry of 62.5% by mass (32% by volume) silicon carbide powder of size range 0.4 micrometers to 8 micrometers in SMP-10 SiC forming polymer. After being coated by the slurry, the sheets are stacked up into a fixture between two graphite plates with shims to control the plate thickness. The plate assembly is then placed into an inert gas or vacuum hot press. The part is heated to roughly 150° C. and a load of roughly 20,000 lbs is applied to compress the plies to the shim thickness. The plate assembly is then heated at 2° C./minute under inert gas while still under load to a temperature of 750-800° C. and held for 1 hour. The plate assembly is cooled, the plate is removed, and vacuum infiltrated with SMP-10 polymer and re-pressed in the hot press using the same procedure as above. Pyrolysis is achieved by heating under inert gas at 1-2 degrees per minute up to 850-1000° C. with a 1 hour hold. The part is then vacuum infiltrated with SMP-10 SiC-forming polymer and pyrolyzed in nitrogen by heating at 1-2 degrees per minute up to 850-1000° C. with a 1 hour hold. The partially densified part is then vacuum infiltrated with SMP-10 SiC-forming polymer and pyrolyzed as done previously until a porosity of less than 7% is reached.

### EXAMPLE 17

### High Temperature Release Coating

A solution of 50% by mass of QS-15-003 in Hexane is painted onto a graphite mandrel, allowed to dry ½ hour in flowing warm air and pyrolyzed under inert gas at a heating rate of 2° C./minute to 850-900° C. with a 1 hour hold. The above process is repeated a minimum of two more times and a maximum of six more times. Light sanding of the mandrel with 600 grit SiC paper after all except for the last pyrolysis cycle assists in providing a very smooth surface. The mandrel can then be used to mold carbon fiber and ceramic fiber composite components without the parts adhering to the mold. Three coating cycles or more will allow the graphite mandrel or mold to withstand molten silicon.

### EXAMPLE 18

### Melt Infiltration Preform

A solution of 20% by mass of QS-15-003 in Hexane is painted onto a chopped, non-woven, or cloth-based carbon fiber perform, allowed to dry ½ hour and pyrolyzed under inert gas at a heating rate of 2° C./minute to 850-900° C. with a 1 hour hold. The above process is repeated a minimum of two more times and a maximum of six more times. The perform is then infused with carbon forming resin such as furfural or phenolic resin and pyrolyzed in inert gas at a heating rate of 2-3 degrees C. per minute up to 850-1000° C. and held for 1 hour. After cooling the perform can be heated to above 1500° C. in vacuum or argon and infiltrated with molten silicon to form a melt infiltrated carbon fiber reinforced SiC composite with greatly improved toughness over existing melt-infiltrated carbon fiber reinforced SiC materials.

### EXAMPLE 19

### ATV/Mountain Bike Brake Material

Aluminosilicate fiber cloth such as Nextel 312 or Silica cloth is cut into 12″×12″ sheets and coated with a solution of 35% QS-15-017 in THF and dried in flowing warm air. The cloth plies are heated at 2-3° C. per minute in inert gas to 700-850° C. and held for 1 hour. The process is repeated two more times. The plies are infiltrated with a slurry of 20% by mass submicron SiC powder and 10% by mass 2-5 micron garnet powder in a 50% solution of SOC-A35 in toluene and allowed to dry in flowing warm air for a minimum of 1 hour. Six of the pre-pregged plies are then stacked up into a thin plate that is placed between two ¼ inch thick flat steel plates with shims to control thickness, and placed into a platen press that has been preheated to 180° C. Once the part temperature reaches a minimum of 140° C., a pressure of 60-100 p.s.i. is applied through the heated platens to compress the plies to the thickness of the shims. The temperature of the plate is brought to 250° C. over a 60 minute span and held at 250° C. for a minimum of 30 minutes while under pressure. The plate is cooled down to below 120° C. and the press is opened. The composite plate is removed from between the steel plates and trimmed as needed. The plate is then placed between two graphite plates and pyrolyzed to 750-900° C. in inert gas by heating at 2° C./minute to the soak temperature and holding for 1 hour. The plate is then vacuum infiltrated with a solution of 35% SOC-A35 in toluene and pyrolyzed. The infiltration and pyrolysis process is repeated until the open porosity is less than 10%. The plate can be cut into a fire resistant panel or a brake component for low energy applications such as a mountain bike or an ATV.

### EXAMPLE 20

### Elevator and Machine Brake Materials

S-glass cloth is cut into 12″×12″ sheets and coated with a solution of 35% QS-15-017 in THF and dried in flowing warm air. The cloth plies are heated at 2-3° C. per minute in inert gas to 700-850° C. and held for 1 hour. The process is repeated two more times. The plies are infiltrated with a slurry of 20% by mass submicron SiC powder and 10% by mass 2-5 micron garnet powder in a 50% solution of SOC-A35 in toluene and allowed to dry in flowing warm air for a minimum of 1 hour. Six of the pre-pregged plies are then stacked up into a ¼-½ inch thick plate that is placed between two ¼ inch thick flat steel plates with shims to control thickness, and placed into a platen press that has been preheated to 180° C. Once the part temperature reaches a minimum of 140° C., a pressure of 60-100 p.s.i. is applied through the heated platens to compress the plies to the thickness of the shims. The temperature of the plate is brought to 250° C. over a 60 minute span and held at 250° C. for a minimum of 30 minutes while under pressure. The plate is cooled down to below 120° C. and the press is opened. The composite plate is removed from between the steel plates and trimmed as needed. The plate is then placed between two graphite plates and pyrolyzed to 750-900° C. in inert gas by heating at 2° C./minute to the soak temperature and holding for 1 hour. The plate is then vacuum infiltrated with a solution of 35% SOC-A35 in toluene and pyrolyzed. The infiltration and pyrolysis process is repeated until the open porosity is less than 10%. The plate can be cut into friction components such as an elevator brakes, machine brakes, or automotive clutch friction segments.

### EXAMPLE 21

### High Temperature Friction Material

QS-15-003 is added to furfural alcohol at a 1.0-2.5% by mass and mixed thoroughly. The furfural alcohol/QS-15-003 mixture is then mixed with 10% by mass garnet powder, and 20% by mass chopped steel fibers, 10% by mass of ¼ inch long pitch based fibers (such as P-25) and 20% by mass ground (−200 mesh) glassy carbon to make a molding compound. The molding compound is pressed into a steel mold and a pressure of 3000 p.s.i. is applied while the mold is heated to 350° C. After removal from the mold, the part is slowly pyrolyzed to 650° C. to 750° C. over a 40 hour cycle, to produce a friction material blank. The material is vacuum infiltrated with furfural and a catalyst and allowed to cure at room temperature for 4 hours. The part is then heated at 1° C./min in inert gas to 850° C. and held for 1 hour. After cooling the part is vacuum infiltrated with a solution of 50% furfural/SOC-A35 in toluene, and allowed to dry in warm flowing air for a minimum of 1 hour. The part is then heated at 1° C./min in inert gas to 850° C. and held for 1 hour. The infiltration and pyrolysis process is repeated until the part has a porosity of less than 8%. The material is then ready for machining into a wet or dry capable friction material.

### EXAMPLE 22

### Ceramic Enhanced Wet Friction/Clutch Pad

A wet friction pad is made by substituting 30%-50% of the standard solid phenolic resin with solid a special variant of SOC-A35 called FM-35 and processed by the nominal existing wet friction component processing route. Once formed, the modified component has ½ to ¼ the wear and more consistent friction when used as wet friction material. In addition, the material will function with much less wear in the event of loss of lubricant/coolant compared to a pad made without the SOC-A35.

### EXAMPLE 23

### High Temperature/Low Dielectric Constant Circuit Board/Packaging Material

S-glass cloth is cut into 12″×12″ sheets and coated with a solution of 35% of a 50:50 mixture of QS-15-003 and QS-15-017 in tetrahydrofuran (THF) and dried in flowing warm air. The cloth plies are heated at 2-3° C. per minute in inert gas to 500-650° C. and held for one hour. The plies are infiltrated with 40% solution of SOC-A35 in ethanol and allowed to dry in flowing warm air for a minimum of 1 hour. Seven of the pre-pregged plies are then stacked up into a ¼-½ inch thick plate that is placed between two ¼ inch thick flat steel plates with shims to control thickness to approximately 0.068 inches, and placed into a platen press that has been preheated to 180° C. Once the part temperature reaches a minimum of 140° C., a pressure of 60-100 p.s.i. is applied through the heated platens to compress the plies to the thickness of the shims. The temperature of the plate is brought to 400° C. over a 60 minute span and held at 400° C. for a minimum of 30 minutes while under pressure. The plate is cooled down to below 70° C. and the press is opened. The composite plate is removed from between the steel plates and trimmed as needed. The plate is then placed between two steel plates and pyrolyzed to 500-650° C. in inert gas by heating at 1° C./minute to the soak temperature and holding for 1 hour. The plate is then vacuum infiltrated with a solution of 35% SOC-A35 in ethanol and pyrolyzed. The infiltration and pyrolysis process is repeated until the open porosity is less than 7%. When polished, the plate and utilized as circuit board or electronic packaging material, the plate has a dielectric constant of 3.35, a dielectric loss factor of 0.005, a volume resistivity of 9×1014 ohms, and can be used at as high as 500° C.

### EXAMPLE 24

### 500° C. Capable Low Dielectric Constant Circuit Board/Packaging Material

E-glass cloth is cut into forty 12″×12″ sheets. The sheets are infiltrated with a slurry of 20% by mass 0.4-4 micron silica powder and 5% by mass fumed silica in a 30% solution of SOC-A35 in toluene and allowed to dry in flowing warm air for a minimum of 1 hour. Thirty seven (37) of the pre-pregged plies are then stacked up into a ¼-½ inch thick plate that is placed between two ¼ inch thick flat steel plates with shims to control thickness to approximately 0.068 inches, and placed into a platen press that has been preheated to 180° C. Once the part temperature reaches a minimum of 140° C., a pressure of 60-100 p.s.i. is applied through the heated platens to compress the plies to the thickness of the shims. The temperature of the plate is brought to 400° C. over a 60 minute span and held at 400° C. for a minimum of 30 minutes while under pressure. The plate is cooled down to below 70° C. and the press is opened. The composite plate is removed from between the steel plates and trimmed as needed. The plate is then placed between two steel plates and pyrolyzed to 500-650° C. in inert gas by heating at 1° C./minute to the soak temperature and holding for 1 hour. The plate is then vacuum infiltrated with QS-15-003 a solution with 5% of a catalyst and pyrolyzed at 1 degree C. per minute to 500-650° C. and held for 1 hour. The infiltration and pyrolysis process is repeated until the open porosity is less than 7%. The plate can now be polished and utilized as low dielectric constant circuit board or electronic packaging material capable of up to 500° C. operation.

The compounds of FIGS. 4 and 5 may be prepared according to Examples 25 and 26, respectively, below.

### EXAMPLE 25

### Preparation of QS-15-003

17143 g (93.2 mols) of chloromethyltrichlorosilane was placed in a 12 L three-necked round bottom flask equipped with a pressure-equalizing dropping funnel, a magnetic stirrer, and a reflux condenser fitted with a nitrogen gas outlet. Tygon tubing connected to this gas let was positioned over water in a large plastic container to absorb the by-product HCl gas. An inlet gas tube was connected at the top of the dropping funnel to flush the flask continuously with nitrogen gas. 5664 g (177 mols) of anhydrous methanol was added over 6 hours while the reaction solution was stirred magnetically. The nitrogen gas flush kept the reaction purged of the by-product HCl gas, which was absorbed by the water. After the addition of methanol was completed, the solution was further stirred for 12 hours at room temperature. The composition of the final product from this procedure is about 75-80% Cl(MeO)₂SiCH₂Cl, 10-15% Cl₂(MeO)SiCH₂Cl, and 2-5% (MeO)₃SiCH₂Cl. This mixture, with an average Cl_{1.1}(OMe)_{1.9}SiCH₂Cl formula, was used directly in next step reaction without purification.

630 g (26.25 mols) of Mg powder (−50 mesh) and 600 ml of anhydrous THF were placed in a 12 L three-necked round bottom flask. The flask was fitted with a dropping funnel, a mechanical stirrer, and a reflux condenser fitted with a gas inlet and supplied with dry nitrogen. 1460 g of Cl_{1.1}(OMe)_{1.9}SiCH₂Cl (8.3 mols) and 31 g (0.41 mols) of allylchloride were mixed with 1600 g of anhydrous THF in the dropping funnel. When the Cl_{1.1}(OMe)_{1.9}SiCH₂Cl mixture was added to the Mg powder, the Grignard reaction started immediately. The solution became warm and developed to a dark brown color. Throughout the addition, the reaction mixture was maintained at a gentle reflux by adjusting the addition rate of the starting material and cooling the reaction flask by cold water. The starting material was added in 2 hours. The resultant mixture was stirred at room temperature for 30-60 minutes. At this stage, a polymer with a [Si(OMe)₂CH₂]_{0.95n}[Si(allyl)(OMe)CH₂]_{0.05n} formula was formed.

1860 g (8.04 mols) of bis(chloromethyl)tetramethyldisiloxane and 2000 g of anhydrous THF were mixed in the same dropping funnel from above reaction. The bis(chloromethyl)tetramethyldisiloxane solution was added to the mixture from the Grignard reaction of Cl_{1.1}(OMe)_{1.9}SiCH₂Cl within 3 hours. When the reaction became warm again, it was cooled by cold water. After the addition of bis(chloromethyl)tetramethyldisiloxane was completed, the resultant mixture was stirred at room temperature for one hour. Then, a heating mantle was placed under the 12 L flask and the mixture was heated to 50° C. overnight to finish the coupling reaction.

To a 30 L plastic container, 1.3 L of concentrated HCl was mixed with 10 kg of crushed ice and 2 L of hexane. The solution was stirred vigorously by a mechanical stirrer. The mixture from the Grignard reaction was poured into the rapidly stirred cold hexane/HCl solution over 30 minutes. Once the addition of the Grignard reaction mixture was completed, the work-up solution was stirred for another 10 minutes. After the stirring was stopped, a yellow organic phase appeared above the aqueous layer. The organic phase was separated and washed with 1000 mL of dilute (1 M) HCl solution, then dried over Na₂SO₄ for 12 hours. After the solvents (hexane/THF) were stripped off by a rotary evaporator, 1650 g of clear and yellowish viscous polymer was obtained. This polymer has a [Si(CH₂SiMe₂O_{1/2})₂CH₂]_{0.95n}[Si(allyl)(CH₂SiMe₂O_{1/2})CH₂]_{0.05n} formula and its weight molecular weight was typically distributed in the range of 500 to 50000.

### EXAMPLE 26

### Preparation of QS-15-017

605 g (25.2 mols) of Mg powder (−50 mesh) and 400 ml of anhydrous THF were placed in a 12 L three-necked round bottom flask. The flask was fitted with a dropping funnel, a mechanical stirrer, and a reflux condenser fitted with a gas inlet and supplied with dry nitrogen. 3003 g of chloromethyldimethylsilane (ClMe₂SiCH₂Cl) (21 mols) was mixed with 3600 g of anhydrous THF, 878 g (7.63 mols) of methyldichlorosilane and 287 g (1.92 mols) of methyltrichlorosilane in the dropping funnel. When the silane mixture was added to the Mg powder, the Grignard reaction started immediately. The solution became warm and developed to a dark brown color. Throughout the addition, the reaction mixture was maintained at a gentle reflux by adjusting the addition rate of the starting material and cooling the reaction flask by cold water. The starting material was added in 5 hours. The resultant mixture was stirred at room temperature for 30-60 minutes. Then, a heating mantle was placed under the 12 L flask and the mixture was heated to 50° C. overnight to finish the coupling reaction.

To a 30 L plastic container, 12 kg of crushed ice was mixed with 2 L of hexane. The solution was stirred vigorously by a mechanical stirrer. The mixture from above Grignard reaction was poured into the rapidly stirred cold hexane/HCl solution over 30 minutes. Once the addition of the reduction mixture was completed, the work-up solution was stirred for another 30 minutes. After the stirring was stopped, a yellow organic phase appeared above the aqueous layer. The organic phase was separated and washed with 500 mL of dilute (1 M) HCl solution, then dried over Na₂SO₄ for 12 hours. Finally, the solvents (hexane/THF) were stripped off by a rotary evaporator. The crude product was further distilled under vacuum, which gave rise to 437 g of low molecular weight materials with bp at 50-130° C./2 torr and 1453 g of viscous yellow polymer. The major component of this polymer has a [SiMe₂CH₂SiMe(H)CH₂SiMe₂O]₄n[SiMe₂CH₂SiMe(CH₂SiMe₂O)₂]ₙ] formula and its weight molecular weight was typically distributed in the range of 500 to 5000.

While this invention has been described in conjunction with the specific embodiments outlined above, it is evident that many alternatives, modifications, and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A compound of formula II 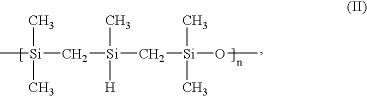
wherein n is at least 2.

2. A method of coating a fiber material comprising the steps of:
desizing the fiber material;
coating the fiber material with a polymer of formula II, 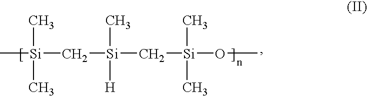
wherein n is greater than 2;
drying the fiber material; and
heating the fiber material.

3. The method of claim 2, wherein the fiber material includes at least one of a carbon fiber, a graphite fiber, a ceramic fiber, a polyacrylnitrile-based fiber, a pitch-based carbon fiber, silicon carbide, near-silicon carbide, silicon borocarbide, silicon carbonitride, silicon nitrocarbide, a refractory metal, a refractory metal carbide, a refractory metal boride, a refractory metal nitride, alumina, mullite, silicon dioxide, or an aluminosilicate.

4. The method of claim 2, wherein the heating step pyrolizes the polymer.

5. The method of claim 2, wherein the heating step includes heating the fiber material to a temperature between about 600° C. and about 700° C.

6. The method of claim 5, wherein the heating step is performed in one of argon and nitrogen.

7. The method of claim 2, wherein the heating step includes heating the fiber material to a temperature between about 850° C. and about 1100° C.

8. The method of claim 7, wherein the heating step is performed in an inert gas.

9. The method of claim 2, wherein the desizing step includes heating the fiber material to a temperature between about 350° C. and about 500° C. in air.

10. The method of claim 2, wherein the desizing step includes heating the fiber material to a temperature of about 850° C. in an inert gas.
